(19) United States
(12) Patent Application Publication
(10) Pub. No.: US 2007/0013106 A1
(43) Pub. Date: Jan. 18, 2007

(54) Method of preparing hydrophobic polymer substrate and hydrophobic polymer substrate prepared by same

(75) Inventors: Seung-Mo Lee, Pohang-City (KR); Tai-Hun Kwon, Pohang-City (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignees: POSTECH ACADEMY-INDUSTRY FOUNDATION, Pohang-City (KR); POSTECH FOUNDATION, Pohang-City (KR)

(21) Appl. No.: 11/225,150

(22) Filed: Sep. 13, 2005

(30) Foreign Application Priority Data
Jul. 14, 2005 (KR) 10-2005-0063691

(51) Int. Cl. B28B 7/36

(52) U.S. Cl. 264/338

(57) ABSTRACT

Disclosed is a method of producing a hydrophobic polymer substrate including coating a curable photopolymer composition on a substrate, locating a micro- and nano-patterned hydrophobic template on the coated substrate, curing the curable photopolymer composition to prepare a curable photopolymer layer, and separating the curable photopolymer layer from the hydrophobic template.

### CROSS REFERENCE TO RELATED APPLICATION

This application claims priority to and the benefit of Korean Patent Application No. 10-2005-0063691 filed in the Korean Intellectual Property Office on May Jul. 14, 2005, the entire content of which is incorporated herein by reference.

### FIELD OF THE INVENTION

The present invention relates to a method of preparing a hydrophobic polymer substrate and a hydrophobic polymer substrate prepared by the same, and more particularly, to a method of preparing a hydrophobic polymer substrate with an easy and simple process.

### BACKGROUND OF THE INVENTION

The wettability of liquid to a surface of a solid such as a polymer material indicates an interaction between the surface of the solid and a molecule of liquid (adsorption of liquid to the surface of a solid), and a competitive phenomenon of adhesion between the solid and liquid and cohesion between molecules of the liquid. A larger cohesion than adhesion brings about a decrease in wettability, and less cohesion than adhesion brings about an increase in wettability.

Good wettability to liquid water refers to hydrophilic properties, and poor wettability refers to hydrophobic properties.

Such wettability can be quantitatively determined by measuring a contact angle of a solid surface. A contact angle of 90° or more indicates a hydrophobic surface and a contact angle of 150° or more indicates a super-hydrophobic surface. The hydrophobic properties mainly depend on chemical properties of the surface and of the micro- and nano-structures thereof. Recently, hydrophobic films have been widely required for various practical applications because of their characteristics such as self-cleaning, anti-fogging, and lack of surface friction fading caused by liquids.

W. Barthlott and C. Neinhuis reported various super-hydrophobic leaves in nature and the topology which results in the various phenomena in 1977. And various methods have been reported in the literature to construct hydrophobic surfaces by modifying structures of the surfaces. Conventionally, hydrophobic surfaces are fabricated with the help of chemical treatment for changing the surface energy of materials or for modifying the surface roughness, for example by polypropylene etching, plasma enhanced chemical vapor deposition (PECVD), plasma polymerization, plasma fluorination of polybutadiene, microwave anodic oxidation of aluminum, solidification of an alkylketene dimer, nanostructuring carbon film, polypropylene coating, carbon nanotube aligning, forming poly(vinyl) alcohol nanofibers, making the surface of polydimethylsiloxane porous, or oxygen plasma treatment.

Some of these methods produce hydrophobic surfaces by controlling the surface topography through complex chemical processes with toxic chemicals, and these methods mentioned above are generally time-consuming or costly. The produced surface from some of these methods is easily contaminated, causing a loss of hydrophobic properties, and some are unstable in the presence of other compounds.

### SUMMARY OF THE INVENTION

In one embodiment of the present invention, a method of producing a hydrophobic polymer substrate is provided that is a simple process to obtain a polymer substrate with good durability.

In another embodiment of the present invention, a hydrophobic polymer substrate prepared by the same is provided.

One embodiment of the present invention is a method of preparing a polymer substrate. In the method, a curable photopolymer composition is coated on a substrate and a micro- and nano-patterned hydrophobic template is located on the coated substrate. The curable photopolymer composition is cured to form a curable photopolymer layer on the substrate and the hydrophobic template is separated from the curable photopolymer layer. As a result, a hydrophobic polymer substrate to which patterns of the hydrophobic template are inversely replicated is produced.

Another embodiment of the present invention provides a polymer substrate prepared by the method.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a block diagram illustrating procedures for producing a hydrophobic polymer substrate of the present invention;

FIG. 2 is a schematic diagram illustrating ultraviolet (UV)-nanoimprint lithography equipment;

FIGS. 3(a) to (d) illustrate various contact angles;

FIG. 4 is a scanning electron microscope (SEM) image of a lovegrass leaf;

FIG. 5 is a CCD (Charge Coupled Device) photo of a water drop on the under-surface of a lovegrass leaf;

FIG. 6 is a SEM image of a polymer film according to Example 1 of the present invention;

FIG. 7 is a CCD photo of a water drop on a polymer film according to Example 1 of the present invention; and

FIG. 8 is a CCD photo of a water drop on a polymer film according to Comparative Example 1.

### DETAILED DESCRIPTION OF THE INVENTION

The present invention relates to a method of preparing a hydrophobic surface. This inventive method is a new and simple method to produce a hydrophobic surface replicating micro- and nano-structures of hydrophobic plant leaves by using a UV-nanoimprint lithography technique, rather than a chemical process.

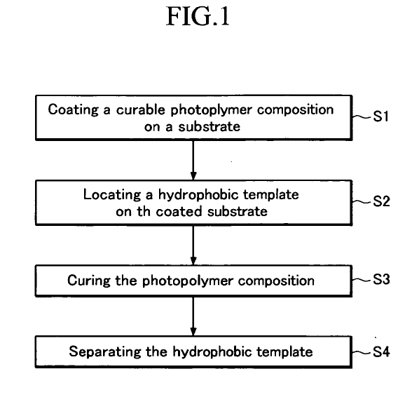

Hereinafter, the inventive method will be illustrated in more detail in reference to the accompanying FIG. 1. A curable photopolymer composition is coated on a substrate (S1), and the curable photopolymer composition includes a curable photopolymer and a photoinitiator.

The curable photopolymer may be any one as long as it is cured by ultraviolet rays. The photopolymer may include, but is not limited to, epoxy resin, acrylic resin, or acrylate-based resin such as ethylene glycol diacrylate or polyimide. The photoinitiator may be an anthraquinone-based compound such as 1-chloro anthraquinone or an epoxide-based compound.

The mixing ratio between the photopolymer and the initiator is not critical and may be suitably controlled. In particular, the initiator is used in a sufficient amount to initiate a curing reaction.

The substrate is a transparent substrate through which ultraviolet rays pass and may generally be a glass substrate.

The coated amount of the photopolymer composition may be suitably controlled, for example to 30 to 40 μl per cm² when a template to be used has an area of 5×5 cm².

Thereafter, a micro- and nano-patterned hydrophobic template is located on the coated substrate (S2) and then cured (S3). The photopolymer composition is cured to prepare a curable photopolymer layer with the replicated micro- and nano-patterned template.

The hydrophobic template is preferably a hydrophobic plant leaf, and is more preferably a leaf having micro- and nano-structures and a contact angle of 1500 or more. Exemplary thereof include leaves of lovegrass, bamboo, silver maple tree, tulip tree, trident maple, rice, lotus, or pyracantha.

The curing step is performed by irradiating ultraviolet rays to the curable photopolymer, and is preferably done through UV-nanoimprint lithography. The exposing is performed under pressure, preferably at 150 kPa or more and more preferably at 150 to 500 kPa. Under a pressure of less than 150 kPa, the pattern of the hydrophobic template is not completely transferred to the photopolymer. In addition, it is preferably that the pressure while exposing is kept constant. If the UV-nanoimprint lithography equipment to be illustrated is used, the pressure indicates applying pressure of a pneumatic cylinder.

The exposing step is preferably performed for 600 seconds or more, and more preferably 600 seconds to 30 minutes. An ultraviolet ray exposure time of less than 600 seconds does not satisfactorily cure the composition, leaving a liquid type or gel type of composition.

The template is separated from the curable photopolymer layer (S4) to produce a hydrophobic polymer substrate to which the hydrophobic template patterns are inversely replicated.

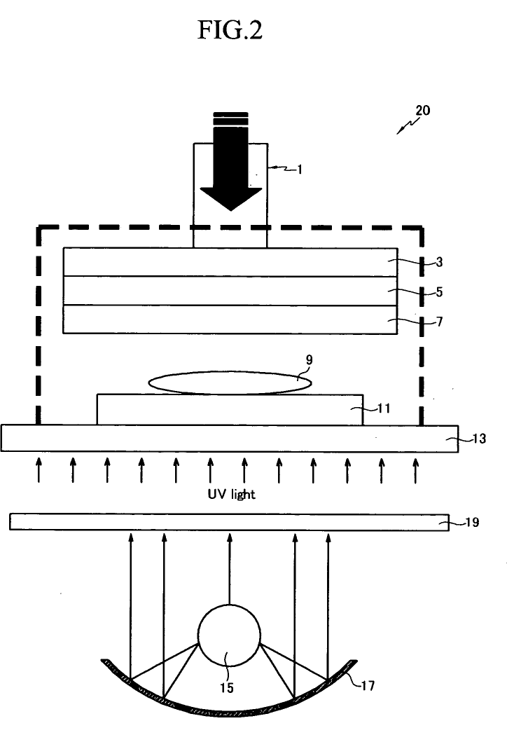

The UV-nanoimprint lithography equipment used in the curing step is shown in FIG. 2. As shown in FIG. 2, the UV-nanoimprint lithography equipment 20 includes a pneumatic cylinder 1, a jig 5 fixing a leaf 7, a vacuum chuck 3 fixing the jig 5, a transparent quartz substrate 13 through which UV rays pass, a glass substrate 11 on which a photopolymer 9 is coated, a UV lamp 15 which cures the photopolymer, a reflector 17, and a UV shutter 19 which controls the irradiation time of the UV rays.

The obtained polymer substrate has a contact angle of 146.5 to 149.5 which indicates a hydrophobic property.

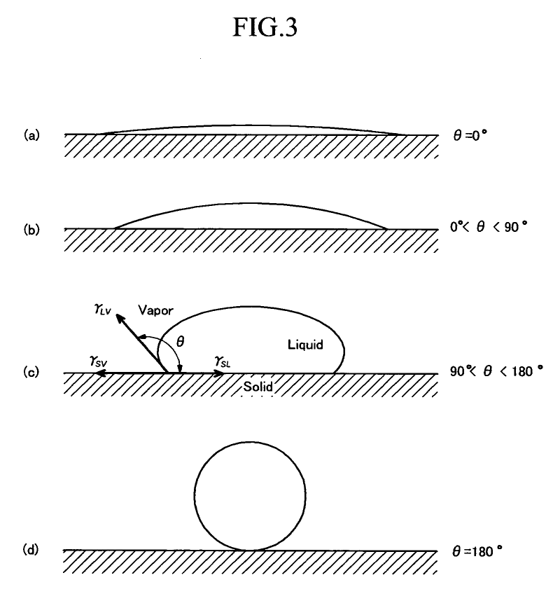

The contact angle is an angle of liquid at a thermodynamic balence on a surface of a solid. As shown in (a) to (d) of FIG. 3, the contact angle is measured at a contact point of a surface of the solid and an end point of a drop at the joined point of liquid-solid-vapor. Thus, (a) of FIG. 3 is a contact angle (θ) of 0, (b) is a contact angle of 0<θ<90°, (c) is a contact angle of 90°<θ<180° and (d) is a contact angle of 180°.

The hydrophobic polymer substrate is applicable to self-cleaning requiring fields such as tiles, varnish, construction, clothing, tools for the kitchen, or a decrease in flowing resistance required fields such as aeronautics, shipping crafts or automobiles.

The following examples illustrate the present invention in more detail. However, it is understood that the present invention is not limited by these examples.

### EXAMPLE 1

A lovegrass leaf was attached on a jig 3 of UV-nanoimprint lithography equipment in a vacuum chamber as shown in FIG. 2. A curable photopolymer composition including an epoxy curable photopolymer and an epoxide initiator (available from Ventico, RenShape SL 5180) was coated on a glass substrate 11 on a quartz substrate 13. At this time, the coated amount of the photopolymer was 1 ml per cm² of the lovegrass leaf.

Thereafter, air and dust were removed from the vacuum chamber and pressure was applied to a pneumatic cylinder 1. The pressure was maintained at 160 kPa or more.

Under the constant pressure, UV was irradiated from a UV lamp 15 to reach the photosensitive resin layer 9 via a UV shutter 19 and the quartz substrate 13. The UV irradiation was performed for 720 seconds and the UV lamp 15 was an MRL 1500 UV lamp available from SEM Co., Ltd.

When the UV irradiation was completed the vacuum chamber was depressurized following by detaching the replicated film from the jig 3, thereby producing a hydrophobic polymer substrate.

### COMPARATIVE EXAMPLE 1

A polymer film was produced by irradiating UV to a photosensitive resin composition (Ventico, RenShape SL 5180) for 720 seconds.

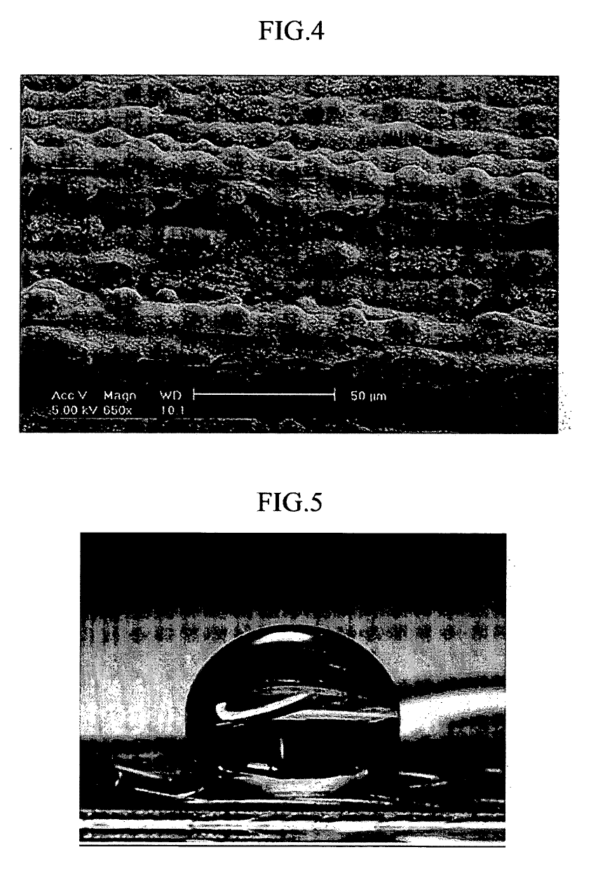

FIG. 4 shows a SEM image of micro- and nano-structures of a lovegrass leaf, and FIG. 5 shows a water drop on the under-surface of a lovegrass leaf after 5 μl of water was dropped to the leaf. The contact angle was measured at ten distinct positions using 5 μl of water and averaged. The contact angle was found to be 154°.

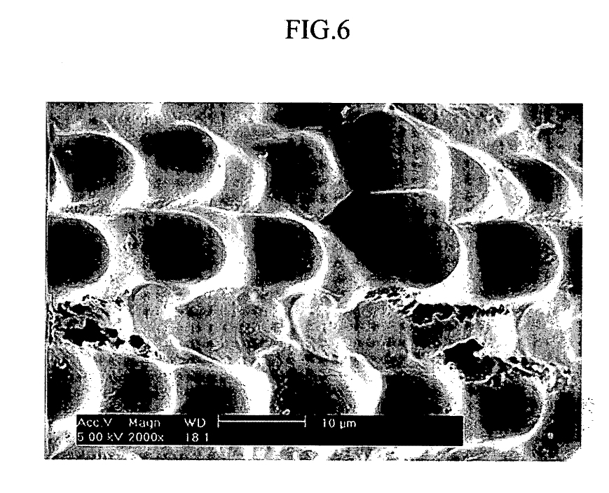

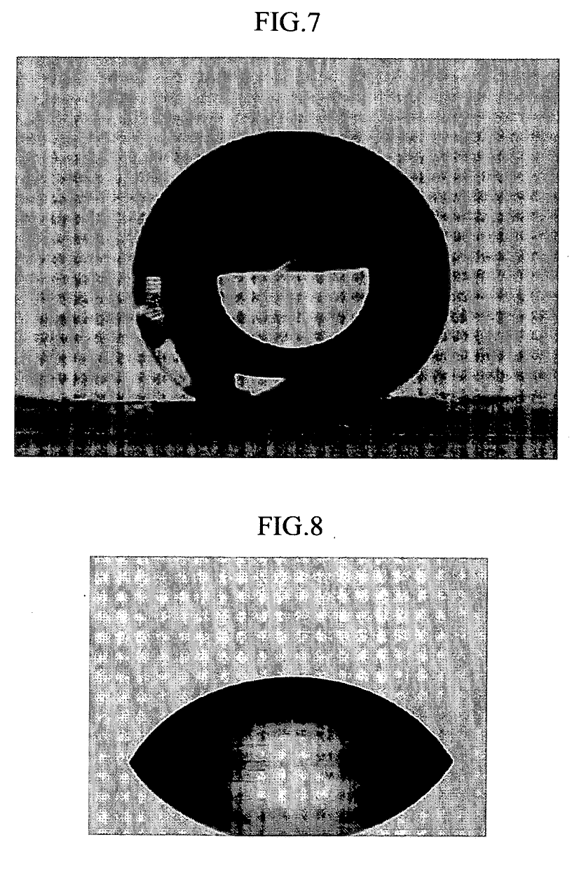

FIG. 6 shows a SEM image of the hydrophobic polymer film according to Example 1. The surface of the hydrophobic film was identical to the surface of the lovegrass leaf. FIG. 7 shows a water drop on the under-surface of the polymer film after 5 μl of water was dropped to the polymer film. The contact angle was found to be 148° which is similar to that of lovegrass, thereby indicating a hydrophobic property.

FIG. 8 shows a water drop on a flat and smooth polymer film according to Comparative Example 1 after 5 μl of water was dropped to the polymer film. The contact angle was found to be 56°.

It is shown from the results that the modification of the structure of the surface increases the contact angle by 92° and makes it hydrophobic.

As described above, the present invention is a simple process to produce a hydrophobic film by replicating the surface structure of a hydrophobic leaf by a UV-nanoimprint lithography technique. In addition, the photocurable polymer used that has good durability renders use for a long time without deformation or denaturation. Furthermore, the polymer substrate of the present invention is applicable to various fields such as tiles, varnishes, construction, clothing, tools for the kitchen, aeronautics, shipping crafts or automobiles, as well as microchips.

While the present invention has been described in detail with reference to the preferred embodiments, those skilled in the art will appreciate that various modifications and substitutions can be made thereto without departing from the spirit and scope of the present invention as set forth in the appended claims.

1. A method of producing a hydrophobic polymer substrate to which micro- and nano-patterns of a hydrophobic template are inversely replicated, comprising:
coating a curable photopolymer composition on a substrate to prepare a coated substrate;
locating the micro- and nano-patterned hydrophobic template on the coated substrate;
curing the curable photopolymer composition to prepare a curable photopolymer layer; and
separating the curable photopolymer layer from the hydrophobic template.

2. The method of claim 1, wherein the hydrophobic template is a hydrophobic leaf.

3. The method of claim 2, wherein the hydrophobic leaf has a contact angle of 150° or more.

4. The method of claim 2, wherein the hydrophobic leaf is a leaf of one or more selected from the group consisting of lovegrass, bamboo, silver maple tree, tulip tree, trident maple, rice, lotus and pyracantha.

5. The method of claim 1, wherein the curing is performed by exposing the curable photopolymer to ultraviolet ray.

6. The method of claim 5, wherein the exposing is a UV nanoimprint lithography technique.

7. The method of claim 5, wherein the exposing is performed under a pressure of 150 kPa or more.

8. The method of claim 7, wherein the exposing is performed under a pressure of 150 to 500 kPa.

9. The method of claim 5, wherein the exposing is performed for 600 seconds or more.

10. The method of claim 9, wherein the exposing is performed for 600 seconds to 30 minutes.

11. A polymer substrate having a contact angle of 146.5 to 149.5°, prepared by the method of claim 1.
